(19) United States
(12) Patent Application Publication
(10) Pub. No.: US 2020/0309688 A1
(43) Pub. Date: Oct. 1, 2020

(54) MOISTURE DISTRIBUTION IMAGE PHOTOGRAPHING APPARATUS, IMPLEMENT INCLUDING THE SAME AND HAVING MOISTURE DISTRIBUTION IMAGE PHOTOGRAPHING FUNCTION, AND SYSTEM INCLUDING THE IMPLEMENT HAVING MOISTURE DISTRIBUTION IMAGE PHOTOGRAPHING FUNCTION

(71) Applicant: SAMSUNG ELECTRONICS CO., LTD., Suwon-si (KR)

(72) Inventors: Changyoung PARK, Yongin-si (KR); Sanghun Lee, Seoul (KR); Sungwoo Hwang, Seoul (KR)

(73) Assignee: SAMSUNG ELECTRONICS CO., LTD., Suwon-si (KR)

(21) Appl. No.: 16/831,202

(22) Filed: Mar. 26, 2020

Related U.S. Application Data
(60) Provisional application No. 62/827,264, filed on Apr. 1, 2019.

(30) Foreign Application Priority Data
Jun. 13, 2019 (KR) 10-2019-0070064

(51) Int. Cl. G01N 21/3554; H04N 5/225; G06T 11/60; G01N 21/359

(52) U.S. Cl. CPC G01N 21/3554; H04N 5/2257; G01N 21/359; H04N 5/2253; G06T 11/60; H04N 5/2258

(57) ABSTRACT

A skin care apparatus having a moisture distribution image photographing function includes a frame having at least one function and a moisture distribution image photographing apparatus mounted on the frame, the moisture distribution image photographing apparatus including a substrate, an image sensor mounted on the substrate, and a lens that collects incident light on the image sensor, the substrate including a circuit module for driving the image sensor and processing an image obtained through the image sensor, and the image sensor including a moisture sensor array in which the center of a main absorption wavelength is in a short wavelength infrared (SWIR) ray band.

### CROSS-REFERENCE TO RELATED APPLICATIONS

This application is based on and claims the benefit of U.S. Provisional Application No. 62/827,264, filed on Apr. 1, 2019, and is also based on and claims priority under 35 U.S.C. § 119 to Korean Patent Application No. 10-2019-0070064, filed on Jun. 13, 2019, in the Korean Intellectual Property Office, the disclosures of which are incorporated by reference herein in their entireties.

### BACKGROUND

### 1. Field

The disclosure relates to acquisition of moisture distribution images, and more particularly, to moisture distribution image photographing apparatuses, an implement including the same and having a moisture distribution image photographing function, and systems including the implement having a moisture distribution image photographing function.

### 2. Description of Related Art

Various sensors are used to achieve a normal operation of a device or a specific purpose. For example, thermal sensors for heat detection, temperature sensors for temperature detection, proximity sensors for collision avoidance, several sensors for autonomous driving, biosensors for detection of biomaterials, humidity sensors for humidity measurement, skin moisture sensors to measure skin moisture are used.

Moisture sensors or moisture meters are one of the sensors used in the field of beauty and therapy of skin. Skin moisture may be measured using a moisture measuring device equipped with a moisture sensor. Moisture measurements are typically performed through an electrical characteristic analysis while a moisture measuring device is in contact with a desired location on the skin. In this case, the contact is in the form of a point contact, and thus, moisture of a specific point where the moisture measuring device is in contact with the skin may be measured.

### SUMMARY

According to embodiments, there are provided moisture distribution image photographing apparatuses that may be used to acquire a moisture distribution image of a region having a given region.

According to embodiments, there are provided various implements to which the moisture distribution image photographing apparatus is mounted to have a moisture distribution image photographing function and systems including the implements.

Additional aspects will be set forth in part in the description which follows and, in part, will be apparent from the description, or may be learned by practice of the presented embodiments of the disclosure.

In accordance with an aspect of the disclosure, a moisture distribution image photographing apparatus includes an image sensor mounted on a substrate and a lens collecting incident light on the image sensor, wherein the substrate includes a circuit module for driving the image sensor and processing an image obtained through the image sensor, and the image sensor includes a moisture sensor array having a main absorption wavelength band of 1450±50 nm or 1920±50 nm.

According to an embodiment, the circuit module may include a communication module configured to transmit the obtained moisture distribution image to the outside of the moisture distribution image photographing apparatus.

According to an embodiment, the moisture distribution image photographing apparatus may further include a band pass filter for blocking visible light.

In accordance with an aspect of the disclosure, an implement having a moisture distribution image photographing function includes a frame and a moisture distribution image photographing apparatus mounted on the frame, wherein the moisture distribution image photographing apparatus includes an image sensor mounted on the substrate and a lens collecting incident light on the image sensor, the substrate includes a circuit module for driving the image sensor and processing a moisture distribution image obtained through the image sensor, and the image sensor includes a moisture sensor array.

The implement having the moisture distribution image photographing function may be a skin care apparatus.

The implement may further include a light source that emits only infrared rays of a SWIR band on the frame. The frame may further include a color camera module or a black and white camera module. According to an embodiment, a plurality of light emitting diodes (LEDs) may further be provided on the frame. According to an embodiment, the frame may be an LED mask worn on a face of a user. According to an embodiment, the frame may include a plurality of light sources, and the number of the moisture distribution image measuring apparatus mounted on the frame may be the same as the number of the plurality of light sources.

According to an embodiment, the frame may include a display region for displaying a moisture distribution image obtained through the moisture distribution image measuring device.

According to an embodiment, the implement may include an algorithm configured to synthesize an infrared image obtained through the moisture distribution image measuring device and an image obtained through the camera module.

In accordance with an aspect of the disclosure, a skin care system includes a skin care apparatus having a moisture distribution image photographing function with respect to a subject and an external device having a display region for displaying a moisture distribution image transmitted from the skin care apparatus. The skin care apparatus and the external device may be connected to each other by a wire or wirelessly.

According to an embodiment, the external device may include an electronic device including a display panel for displaying a moisture distribution image transmitted from the skin care apparatus to be viewed by a user.

According to an embodiment, the external device may include an algorithm configured to synthesize two images obtained through the skin care apparatus, for example, for synthesizing a moisture distribution image of the subject obtained through the skin care apparatus and a black and white or a color image of the subject.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of a moisture sensor according to one embodiment;

FIG. 2 is a plan view of a moisture sensor array including the moisture sensor of FIG. 1;

FIG. 3 is a cross-sectional view of a moisture distribution image photographing apparatus according to an embodiment;

FIG. 4 is a cross-sectional view of a moisture distribution image photographing apparatus according to an embodiment;

FIG. 5 is a perspective view of a first implement including a camera module as a moisture distribution image photographing apparatus, according to an embodiment;

FIG. 6 is a front view of an inner side of the first implement of FIG. 5;

FIG. 7 is a perspective view of a second implement in which a camera module is mounted as a moisture distribution image photographing apparatus, according to an embodiment;

FIG. 8 is a front view of an inner side of a third implement in which a camera module is mounted as a moisture distribution image photographing apparatus, according to an embodiment;

FIG. 9 is a front view of an inner side of a fourth implement in which a camera module is mounted as a moisture distribution image photographing apparatus, according to an embodiment;

FIG. 10 is a front view of a fifth implement in which a camera module is mounted as a moisture distribution image photographing apparatus, according to an embodiment;

FIG. 11 illustrates a moisture distribution image photographing system according to an embodiment;

FIG. 12 is a perspective view of a sixth implement including a camera module as a moisture distribution image photographing apparatus, according to an embodiment;

FIG. 13 is a plan view of a modified example of the camera modules mounted in the implements of FIGS. 5 through 12;

FIG. 14 is a plan view of a modified example of the camera modules and light sources mounted in the implements of FIGS. 5 through 12; and

FIGS. 15 and 16 are cross-sectional views of a moisture sensor according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

An existing moisture measuring device measures moisture through a point contact, and thus, it is possible to measure only the amount of moisture in a contacted portion and it is difficult to obtain a moisture distribution image of a predetermined area.

When using bulky equipment that may accommodate a face, it may be possible to measure a moisture distribution on a face in the form of an image. However, such equipment requires a large space and is expensive, and thus, it is difficult for an individual to purchase and carry the equipment.

Therefore, the present inventive concept discloses various moisture distribution image photographing apparatuses by which a moisture distribution image of a predetermined area may be easily obtained by a non-contact and non-invasive method and that have higher portability and accessability than an existing moisture distribution image photographing apparatus and are conveniently used, and various implements and systems to which the moisture distribution image photographing apparatuses are applied.

Hereinafter, moisture distribution image photographing apparatuses including a moisture sensor array according to embodiments, implements having such a moisture distribution image photographing apparatus mounted thereon and having a moisture distribution image photographing function, and systems including the implements will be described in detail with reference to the accompanying drawings. In the drawings, the thicknesses of layers or regions are exaggerated for clarity. The implement and system having the moisture distribution image photographing function may be, for example, a skin care apparatus and a skin care system.

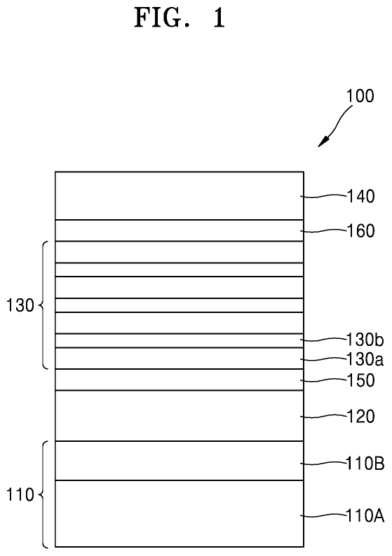

FIG. 1 shows a moisture sensor 100 according to an embodiment.

Referring to FIG. 1, the moisture sensor 100 may include a substrate 110 and a first semiconductor layer 120, a photoelectric conversion layer 130, and a second semiconductor layer 140 sequentially stacked on the substrate 110. The first semiconductor layer 120, the photoelectric conversion layer 130, and the second semiconductor layer 140 are sequentially stacked in a direction perpendicular to a surface of the substrate 110, on which the first semiconductor layer 120 is deposited. The substrate 110 may be transparent or opaque to incident light. The substrate 110 may include, for example, a Si layer, a GaAs layer, a Ge layer, or an InP layer. The substrate 110 may be doped with an impurity. The substrate 110 may include a base substrate 110A and a buffer layer 110B sequentially stacked. The base substrate 110A may include a Si layer, a Ge layer, or a GaAs layer, but is not limited thereto. The buffer layer 110B may include a single layer or multiple layers. The buffer layer 110B may include at least one of a Ge layer, a GaAs layer, and an InP layer, but is not limited thereto. For example, when the base substrate 110A includes a Si layer, the buffer layer 110B may have a multilayer structure including a Ge layer, a GaAs layer, and an InP layer. In another example, when the base substrate 110A includes a Ge layer, the buffer layer 110B may have a multilayer structure including a GaAs layer and an InP layer. In another example, when the base substrate 110A includes a GaAs layer, the buffer layer 110B may include an InP layer.

The first and second semiconductor layers 120 and 140 may be transparent to incident light. The incident light may include infrared light. At least one of the first and second semiconductor layers 120 and 140 may be transparent with respect to short wavelength IR (SWIR) having a center wavelength in a range from 1300 nm to 2100 nm. In an example, at least one of the first and second semiconductor layers 120 and 140 may be transparent with respect to SWIRs having a center wavelength of 1310 nm, 1450 nm, 1620 nm, 1920 nm, and 2050 nm. In another example, at least one of the first and second semiconductor layers 120 and 140 may be transparent with respect to SWIRs having a wavelength band of 1450±50 nm or 1920±50 nm. One of the first semiconductor layer 120 and the second semiconductor layer 140 may include a semiconductor layer including a p-type impurity, and the other one may include a semiconductor layer including an n-type impurity. For example, the first semiconductor layer 120 may include an n-type semiconductor layer, and the second semiconductor layer 140 may include a p-type semiconductor layer. The first and second semiconductor layers 120 may include compound semiconductor layers or non-compound semiconductor layers.

The photoelectric conversion layer 130, referred to as an active layer, may include a layer that absorbs infrared rays in a given band, for example, infrared rays in a SWIR band, and causes photoelectric conversion. The infrared rays of the SWIR band may include, for example, infrared rays having a central wavelength that is a moisture absorption wavelength. Here, the moisture absorption wavelength refers to a wavelength that is relatively well absorbed to moisture compared to other wavelengths. The central wavelength of the moisture absorption wavelength may be 1450 nm or 1920 nm. The moisture absorption wavelength may include a wavelength of a 1450±50 nm band or a 1920±50 nm band. The photoelectric conversion layer 130 may be transparent to other SWIRs other than the SWIRs having the moisture absorption wavelength. Accordingly, when SWIRs are incident on the photoelectric conversion layer 130, the SWIRs of which the center wavelength corresponds to the moisture absorption wavelength are absorbed by the photoelectric conversion layer 130, and remaining SWIRs may pass through the photoelectric conversion layer 130.

In another example, another photoelectric conversion layer may be added below the photoelectric conversion layer 130, and a center wavelength absorbed by the added photoelectric conversion layer may be different from the moisture absorption wavelength, which will be described below.

The photoelectric conversion layer 130 may include a single layer that generates a photoelectric current (an infrared ray current) by generating photoelectric conversion with respect to infrared rays in a SWIR band. In another example, the photoelectric conversion layer 130 may include a plurality of layers that cause photoelectric conversion with respect to infrared rays in a SWIR band. For example, the photoelectric conversion layer 130 may include one or more of multiple quantum well (MQW) layers 130b and one or more of quantum barrier (QB) layers 130a. The QB layers 130a and the MQW layers 130b may form a layer structure in which the QB layers 130a and the MQW layers 130b are sequentially alternately stacked with each other. In this layer structure, the bottom layer and the top layer may be the QB layer 130a. The MQW layer 130b may include a material that causes photoelectric conversion with respect to infrared rays in a SWIR band. The material of the MQW layer 130b may be, for example, any one of InAs, InGaAs, InGaAlAs, AlGaAs, InGaP, InAlP, InAsP, InGaAsP, InGaAlP, and InAlAsP. The MQW layers 130b may be uniformly disposed at given intervals, but may not be limited thereto. The MQW layer 130b may have a constant thickness within a given range, but is not limited thereto. The QB layer 130a is disposed between the MQW layers 130b. The QB layer 130a may have a constant thickness within a given range, but is not limited thereto. The QB layer 130a may include any one of InAs, InGaAs, InGaAlAs, AlGaAs, InGaP, InAlP, InAsP, InGaAsP, InGaAlP, and InAlAsP. In an example, the QB layer 130a and the MQW layer 130b may include materials of components different from each other. In an embodiment, the components of the material constituting the QB layer 130a and the components of the material constituting the MQW layer 130b may be the same from each other but different in content. For example, both the QB layer 130a and the MQW layer 130b may be an InGaAs layer or include an InGaAs layer, but the content of any one component, for example, In, may be different in the QB layer 130a and the MQW layer 130b)

In an embodiment, the moisture sensor 100 may include a first DBR layer 150 and a second DBR layer 160, e.g., distributed Bragg reflectors. The first DBR layer 150 is disposed between the first semiconductor layer 120 and the photoelectric conversion layer 130. The first semiconductor layer 120, the first DBR layer 150, and the photoelectric conversion layer 130 are sequentially stacked in a direction perpendicular to a surface of the substrate 110, on which the first semiconductor layer 120 is deposited. The second DBR layer 160 is disposed between the photoelectric conversion layer 130 and the second semiconductor layer 140. The first DBR layer 150 and the second DBR layer 160 are disposed to face each other with the photoelectric conversion layer 130 therebetween. The first DBR layer 150 has a layer structure in which first and second material layers having refractive indices different from each other are alternately stacked. As an example of the layer structure of the first DBR layer 150, components of the first and second material layers may be different from each other, and in another example, the components of the first and second material layers may be the same from each other, but the content of any one of the components may be different. The first and second material layers of the first DBR layer 150 may include different materials selected from the group consisting of InAs, InGaAs, InGaAlAs, AlGaAs, InGaP, InAlP, InAsP, InGaAsP, InGaAlP, and InAlAsP, and although the first and second material layers include the same material, the content of each component may be different. A material used as the first DBR layer 150 is different from a material used as the photoelectric conversion layer 130. The layer structure of the second DBR layer 160 may be the same as or different from the layer structure of the first DBR layer 150.

When the first and second DBR layers 150 and 160 are provided, the first and second DBR layers 150 and 160 and the photoelectric conversion layer 130 may form a resonant layer by appropriately controlling an optical thickness of the photoelectric conversion layer 130, and thus, light may be concentrated on the photoelectric conversion layer 130. That is, the photoelectric conversion layer 130 may become a light concentrating layer, thereby increasing photoelectric conversion efficiency. This result may increase the sensitivity and accuracy of the moisture distribution image measurement.

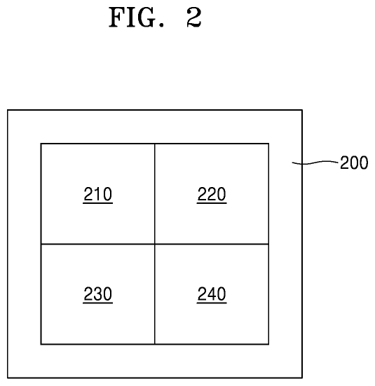

FIG. 2 shows an example of a moisture sensor array including the moisture sensor 100 of FIG. 1.

The moisture sensor array of FIG. 2 may act as a detector for measuring a moisture distribution image of an entire area or a partial area of a predetermined area of a subject.

Referring to FIG. 2, the moisture sensor array may include a plurality of moisture sensors 210, 220, 230, and 240 disposed on a substrate 200. In FIG. 2, although it is depicted that the moisture sensor array includes the four moisture sensors 210, 220, 230, and 240 for convenience of explanation, the moisture sensor array may actually include more than four moisture sensors. Each of the four moisture sensors 210, 220, 230, and 240 may be the moisture sensor 100 described with reference to FIG. 1. Accordingly, the center of the main absorption wavelength of the moisture sensor array of FIG. 2 may be 1450 nm or 1920 nm, and the wavelength absorption may be relatively high for SWIRs in a 1450±50 nm band or a 1920±50 nm band compared to other wavelength bands.

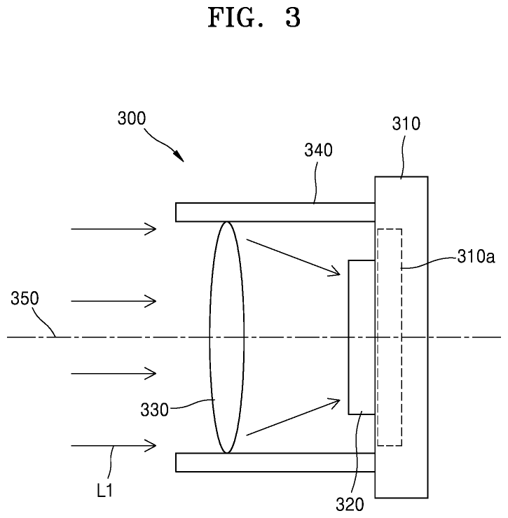

FIG. 3 shows a first camera module 300 including a moisture sensor array as a moisture distribution image photographing apparatus according to an embodiment.

Referring to FIG. 3, the first camera module 300 may include a base substrate 310, an image sensor 320, a lens 330, and a housing 340. The base substrate 310 may include a control board of a measured moisture distribution image. Accordingly, the base substrate 310 may include a circuit or a circuit module 310a for processing a moisture distribution image obtained through the image sensor 320 and driving the image sensor 320. The circuit module 310a may include a communication module for sending an obtained moisture distribution image to the outside of the first camera module 300. The communication module may be connected to the outside of the first camera module 300 via a wire or wirelessly. The communication module may be arranged to be connected to the circuit module 310a on the base substrate 310, and may be arranged to be distinguished from the circuit module 310a. The circuit module 310a is electrically connected to the image sensor 320. The image sensor 320 may be disposed on a surface of the base substrate 310 and may be disposed on a left side of the base substrate 310 as illustrated in FIG. 3. When the first camera module 300 of FIG. 3 is rotated in a clockwise direction, the surface of the base substrate 310 may become an upper surface of the base substrate 310. The image sensor 320 may be the moisture sensor array of FIG. 2 or may include the moisture sensor array of FIG. 2. Accordingly, the center of a main absorption wavelength of the image sensor 320 may be 1450 nm or 1920 nm, which is the center of the moisture absorption wavelength, and may exhibit relatively high wavelength absorption in a 1450±50 nm band or a 1920±50 nm band compared to other wavelength bands. Therefore, for example, the image sensor 320 may include an image sensor specialized for measuring a moisture distribution image of a subject or an image sensor exclusively for measuring a moisture distribution image of a subject. The lens 330 may include an optical lens that focuses incident light L1 on the image sensor 320. The light L1 may be light reflected from the subject. The subject may be, for example, a human or an object from which a moisture distribution is to be measured. When the subject is a human, the skin may be an object, for example, the skin of a face, hands, or legs. When the subject is an object, the object may be any object having a surface area where there may be moisture. The light L1 may be infrared rays reflected from the subject, for example, a SWIR band including infrared rays having a relatively high absorption rate with respect to moisture. The lens 330 may include, for example, a convex lens. The lens 330 may include a lens in which a refractive characteristic may be electro-optically controlled, and thus, a focal length may vary. The lens 330 may include a single lens. In another example, the lens 330 may include a lens system that includes a plurality of lenses to perform the same role as a single lens. The lens 330 is spaced apart from the image sensor 320 along an optical axis 350. A separation distance between the lens 330 and the image sensor 320 may correspond to a focal length of the lens 330. The lens 330 and the image sensor 320 may be arranged in a row on the optical axis 350. The housing 340 is disposed on a surface of the base substrate 310 in a direction perpendicular to the surface of the base substrate 310. The housing 340 may act as a case or a barrel surrounding the image sensor 320 and the lens 330. At least a portion of the housing 340 may be parallel to the optical axis 350. The housing 340 may be in direct contact with the lens 330 as shown in FIG. 3. The housing 340 may be spaced apart from the image sensor 320.

Meanwhile, as described above, when the lens 330 is a variable focus lens, the lens 330 may be moved along the optical axis 350. The housing 340 may be provided to accommodate the above case. For example, the housing 340 may have a case structure or a barrel structure in which a length thereof may be controlled in a sliding manner or in a corrugated manner in a direction parallel to the optical axis 350.

Also, although not shown, the first camera module 300 may include an aperture limiting a part of the incident light L1. The aperture may be disposed in front of or behind the lens 330.

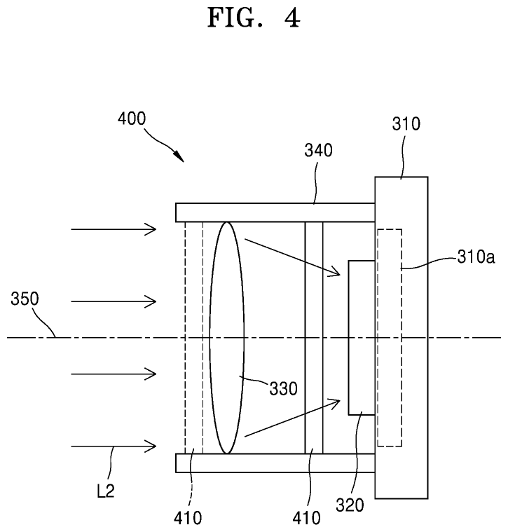

FIG. 4 shows a second camera module 400 including a moisture distribution measuring array as a moisture distribution image photographing apparatus according to an embodiment. Only parts different from the first camera module 300 of FIG. 3 will be described. Like reference numerals used in FIG. 3 may indicate the same members.

Referring to FIG. 4, a band pass filter 410 is disposed between the lens 330 and the image sensor 320 of the second camera module 400. The band pass filter 410 may be a visible light blocking filter that removes visible light components from incident light L2 or may include the visible light blocking filter. The band pass filter 410 may include a band pass filter that passes moisture absorption wavelengths in a band of 1450±50 nm or 1920±50 nm having a central wavelength of 1450 nm or 1920 nm and blocks other wavelengths. In another example, the band pass filter 410 of the second camera module 400 may be replaceably disposed. Accordingly, when the second camera module 400 is used, a subject image including a moisture distribution image may be captured using light of a moisture absorption wavelength and a subject image that does not include a moisture distribution image may be captured using light of a wavelength different from the moisture absorption wavelength through replacing the band pass filter 410.

Due to the band pass filter 410, only the SWIRs of 1450±50 nm or 1920±50 nm band may be incident on the image sensor 320. The band pass filter 410 may be moved to a front side of the lens 330. The light L2 incident on the second camera module 400 may be natural light reflected from a subject. The light L2 may be light reflected by the subject after irradiating light to the subject from a separate light source. The subject may be the one described with reference to FIG. 3.

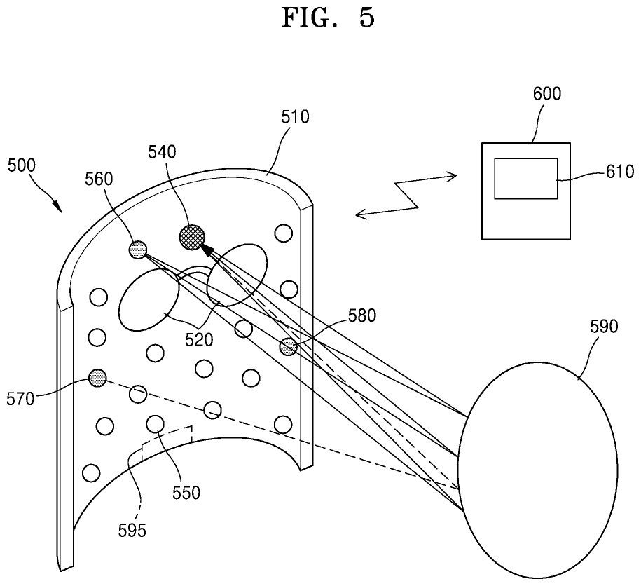

FIG. 5 shows an example of a first implement 500 in which a camera module is mounted as a moisture distribution image photographing apparatus. The first implement 500 may be an example of a skin care device having a moisture distribution image photographing function.

The first implement 500 may be a light emitting diode (LED) mask equipped with a camera module 540 for photographing moisture distribution images. The first implement 500 includes a frame 510 in a mask form and a plurality of light sources disposed on an inner surface of the frame 510, an eye cover or eye protector 520, and the camera module 540. The plurality of light sources may include one or more of first light sources 550 and a second light source 560. The first light sources 550 may be uniformly distributed on an inner surface of a mask so that light may be uniformly irradiated onto a predetermined region of a face 590 (for example, an entire face except for eyes or both cheeks of the face) of a user wearing the first implement 500. The first light source 550 may include, for example, an LED light source for skin therapy. The second light source 560 may be disposed adjacent to the camera module 540. The second light source 560 may be a light source that emits a light component for photographing a moisture distribution image of the face 590 of a user or may include such a light source. The second light source 560 may be a light source that emits infrared rays, for example, may be an infrared emission light source that emits SWIRs in the 1450±50 nm or 1920±50 nm band or may include such a light source. When the second light source 560 is the infrared emission light source described above, the camera module 540 may be the first camera module 300 of FIG. 3 or may include the first camera module 300.

The second light source 560 may be a light source that emits light including both visible light and the SWIR. When the second light source 560 is the light source described above, the camera module 540 may be the second camera module 400 of FIG. 4 or may include the second camera module 400. A moisture distribution image of the face 590 photographed by the camera module 540 may be transmitted to an external device 600 through a communication module provided in the camera module 540. A system including the first implement 500 and the external device 600 may be a skin care system having a moisture distribution image measuring function. The external device 600 may be an electronic device having a display area 610 for displaying a signal or an image transmitted through the communication module included in the camera module 540 to a user or may include the electronic device. For example, the external device 600 may include one of a mobile phone, a mobile pad, a television, a computer and a portable display. The captured moisture distribution image of the face 590 may be confirmed in real time or non-real time by the external device 600. For this purpose, a moisture distribution image photographing operation of the first implement 500 and an operation of the external device 600 may be interlinked to each other. This interlinking may begin when the camera module 540 of the first implement 500 is turned on. Alternatively, the camera module 540 may be turned on, and then, the interlinking may be started when the external device 600 recognizes that the camera module 540 is turned on.

The non-real time confirmation may denote, after storing the photographed moisture distribution images in the external device 600 as a file, checking the stored moisture distribution image later, for example, after completing photographing. The change of a moisture distribution of the face 590 before and after makeup may be measured through photographing a moisture distribution image of the face 590 through the first implement 500. The ‘make-up’ may include various therapies for the skin of the face 590, such as moisturizing the face 590.

Next, the first implement 500 may further include a third light source 570 and/or a fourth light source 580 in addition to the second light source 560, and more light sources may be included if necessary. The third light source 570 and the fourth light source 580 may be light sources having the same light emission characteristics as the second light source 560. When only the second light source 560 is included, the second light source 560 may be a light source that provides light to most of an area of the face 590 except for the eyes. When the third light source 570 and the fourth light source 580 are provided together with the second light source 560, the second light source 560 may be used as a light source for illuminating a portion corresponding to the forehead of the face 590, the third light source 570 may be used as a light source for illuminating one of both cheeks of the face 590, and the fourth light source 580 may be used as a light source for illuminating the other one of the both cheeks. The second light source 560, the third light source 570, or the fourth light source 580 may be interlinked with the camera module 540. For example, when the operation of the camera module 540 is a turn-on state, the second through fourth light sources 560, 570, and 580 may also be in a turn-on state.

The first implement 500 may be used at a given distance from the face 590, for example, the first implement 500 may be disposed at a position spaced apart by a given distance from the face 590 in a state that the user holds the first implement 500 by stretching a hand. At this time, the inside of the first implement 500 is arranged to face the face 590 of a user. In this state, the camera module 540 and/or the second, third, and fourth light sources 560, 570, and 580 may be operated by turning-on a switch provided in the frame 510 of the first implement 500. The switch may be provided on an inner side or an outer side of the frame 510. For example, a switch unit 595 may be provided at a lower end of the frame 510, and the switch may be installed inside or outside the switch unit 595. The switch may be operated by a touch method or a non-touch method.

In another example, the camera module 540 and/or the second, third, and fourth light sources 560, 570, and 580 may be operated in a state that the first implement 500 is worn on the face 590. In this case, a focus of the lens built in the camera module 540 may be controlled to a short distance.

Meanwhile, the camera module 540 may include a plurality of cameras, and the camera module 540 and the second light source 560 may be included in a single module, which will be described later.

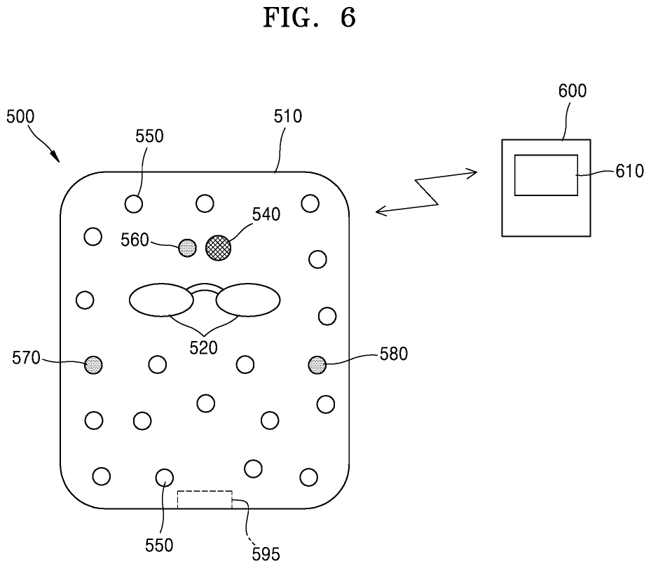

FIG. 6 is a front view of an inner side of the first implement 500 of FIG. 5.

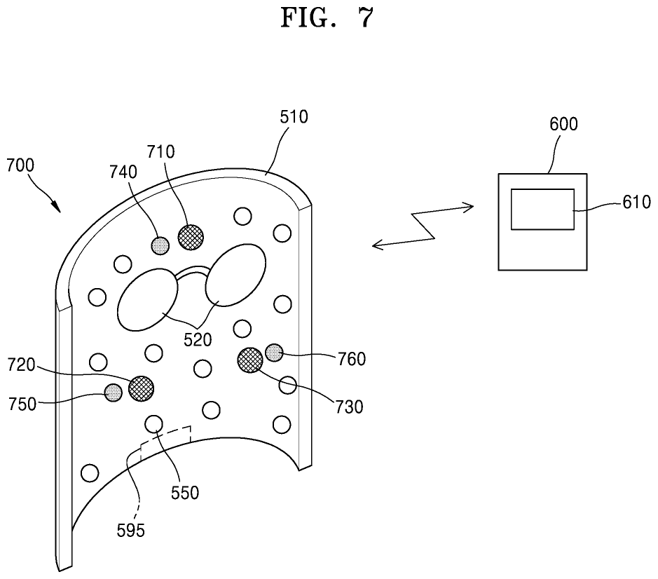

FIG. 7 shows an example of a second implement 700 equipped with a camera module as a moisture distribution image photographing apparatus according to an embodiment. The second implement 700 may be another example of a skin care apparatus capable of photographing a moisture distribution image. The second implement 700 may be an LED mask equipped with a camera module for photographing a moisture distribution image. In describing the second implement 700, only parts different from the first implement 500 described with reference to FIG. 5 will be described, and the same reference numerals described in the first implement 500 indicate the same elements.

Referring to FIG. 7, the second implement 700 may include a plurality of camera modules, for example, first through third camera modules 710, 720, and 730. The configuration and the location of the first camera module 710 may be the same as the camera module 540 of the first implement 500 of FIG. 5, but may be different in configuration. The second camera module 720 and the third camera module 730 are disposed below the eye protector 520. The second camera module 720 may be disposed at a position corresponding to a left cheek of a user who wears the second implement 700. The third camera module 730 may be disposed at a position corresponding to a right cheek of the user who wears the second implement 700. The functions and configurations of the second camera module 720 and the third camera module 730 may be identical to each other, but may differ from each other in configuration. Functions and configurations of the second and third camera modules 720 and 730 may be the same as those of the first camera module 710.

A second light source 740 is disposed adjacent to the first camera module 710. A third light source 750 is disposed adjacent to the second camera module 720. A fourth light source 760 is disposed adjacent to the third camera module 730. If the amount of SWIR to be supplied from the second light source 740 is sufficient for photographing a moisture distribution image of a user, the third and fourth light sources 750 and 760 may be omitted. That is, the second implement 700 may include only one second light source 740 as a light source for supplying SWIRs.

Light emission characteristics of the second through fourth light sources 740, 750, and 760 may be different from light emission characteristics of the first light source 550. The light emission characteristics of the second through fourth light sources 740, 750, and 760 may be the same as light emission characteristics of the second light source 560 of the first implement 500. When the second through fourth light sources 740, 750, and 760 are light sources that emit only light of a SWIR band, the configuration of the first through third camera modules 710, 720, and 730 may be the same as the first camera module 300 of FIG. 3. When the second through fourth light sources 740, 750, and 760 are light sources that emit light including SWIRs and visible light, the configuration of the first through third camera modules 710, 720, and 730 may be the same as the second camera module 400 of FIG. 4. In an example, the first through third camera modules 710, 720, and 730 may be simultaneously operated. In another example, the first through third camera modules 710, 720, and 730 may be selectively operated with respect to each region corresponding to the face 590. When the first through third camera modules 710, 720, and 730 are operated, the second through fourth light sources 740, 750, and 760 may also be operated.

As the first implement 500 of FIG. 5 is interlinked with the external device 600, the second implement 700 may also be interlinked with the external device 600. Also, a system including the second implement 700 and the external device 600 may be a skin care system having a moisture distribution image measurement function.

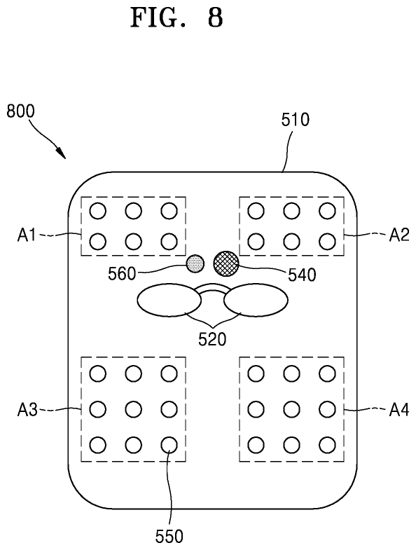

FIG. 8 shows a third implement 800 including the camera module 540 as moisture distribution image photographing apparatuses according to an embodiment. The third implement 800 may be another example of a skin care apparatus having a moisture distribution image photographing function. Parts different from the first implement 500 will be described. Like reference numerals described above indicates identical elements. The illustration of the external device 600 is omitted.

The third implement 800 includes the camera module 540, a plurality of first light sources 550, and a second light source 560. The plurality of first light sources 550 may form a group in a plurality of regions. For example, the plurality of first light sources 550 are present in first through fourth regions A1, A2, A3, and A4 of an inner surface of the frame 510 and are not present in other regions. The first through fourth regions A1 to A4 are spaced apart from each other. The first and second regions A1 and A2 may correspond to the forehead of a face of a wearer who wears the third implement 800. The first and second regions A1 and A2 may be connected to each other. The third region A3 and the fourth region A4 may correspond to both cheeks of the wearer. The third and fourth regions A3 and A4 may be connected to each other. The plurality of first light sources 550 are uniformly distributed in each of the first through fourth regions A1 to A4.

When the second and third camera modules 720 and 730 as described in the second implement 700 of FIG. 7 are provided in the third implement 800, the second camera module 720 may be disposed in the third region A3 and the third camera module 730 may be disposed in the fourth region A4. In this case, one of the first light sources 550 distributed in the third region A3 may be replaced with a light source emitting SWIRs. Also, one of the first light sources 550 distributed in the fourth region A4 may be replaced with a light source that emits SWIRs.

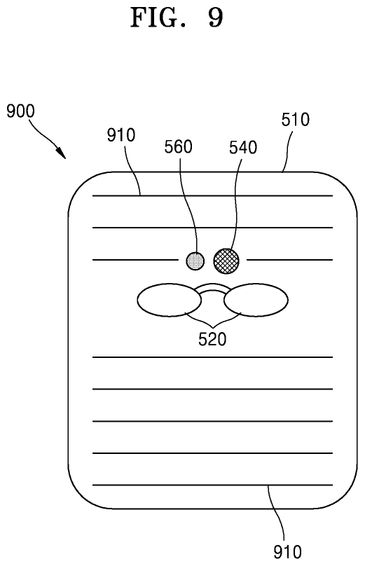

FIG. 9 shows a fourth implement 900 including the camera module 540 as moisture distribution image photographing apparatuses, according to an embodiment. The fourth implement 900 may be another example of a skin care apparatus having a moisture distribution image photographing function. The illustration of the external device 600 is omitted.

Referring to FIG. 9, the fourth implement 900 is the same as the case that the first light sources 550 in the third implement 800 are arranged in a line shape. Horizontal lines indicated by reference numeral 910 symbolically represent the plurality of first light sources 550 arranged in a line form. The case that the first light sources 550 are disposed in a line form may be applied to the second implement 700.

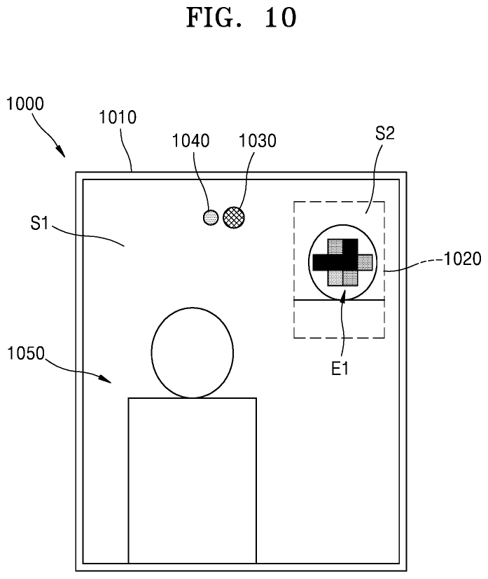

FIG. 10 shows a fifth implement 1000 including a camera module 1030 as a moisture distribution image photographing apparatus, according to an embodiment.

Referring to FIG. 10, the fifth implement 1000 includes a mirror 1010, the camera module 1030, a light source 1040, and a display unit 1020. The camera module 1030 and the light source 1040 may be disposed on a mirror surface S1 of the mirror 1010. That is, the camera module 1030 and the light source 1040 may be completely surrounded by the mirror surface S1. In the fifth implement 1000, the mirror 1010 may be regarded as a frame on which the camera module 1030 and the light source 1040 are mounted. The camera module 1030 may be the camera module 540 of the first implement 500 or may include the camera module 540. The light source 1040 may be the second light source 560 of the first implement 500 or include the second light source 560. The light source 1040 is disposed adjacent to the camera module 1030. The camera module 1030 and the light source 1040 may be included in one module. The display unit 1020 may include a display device that displays a moisture distribution image of a specific portion of a subject. The moisture distribution image is acquired through the camera module 1030. The display unit 1020 may be located in the mirror surface S1. On the display unit 1020, a surface S2 on which a moisture distribution image E1 is directly displayed may be surrounded by the mirror surface S1. The display unit 1020 may be disposed at one of the four corners of the mirror 1010. In the display unit 1020, the surface S2 on which the moisture distribution image E1 is displayed may be a part of the mirror surface S1. Alternatively, a part of the mirror surface S1 may be used as a moisture distribution image display region of the display unit 1020. For example, an entire region of the mirror surface S1 of the mirror 1010, that is, the entire region except for the light source 1040 and the camera module 1030 inside the frame of the mirror 1010 may be a display panel having a mirror function in an off state. In this case, a moisture distribution image of a specific portion of a subject photographed through the camera module 1030 may be displayed on the corresponding surface S2 of the display unit 1020 by maintaining only the surface S2 corresponding to the display unit 1020 on the mirror surface S1 in an on-state. The subject may be a user, that is, a person who uses the mirror 1010, and the specific part of the subject may be a part or the whole of face of a person, or the skin of another part of the body such as a person's hand or arm. In the moisture distribution image E1, darker color portions may be portions where moisture is relatively large and lighter color portions may be portions where moisture is relatively low.

In FIG. 10, reference numeral 1050 indicates a subject reflected in the mirror 1010. The moisture distribution image E1 displayed on the surface S2 on which the moisture distribution image of the display unit 1020 is displayed may be a moisture distribution image of a face of the subject 1050 reflected on the mirror surface S1.

In an example, the fifth implement 1000 may be a smart mirror placed in a room or bathroom. In another example, the fifth implement 1000 may be a mirror cap that reflects a face of a cosmetic compact.

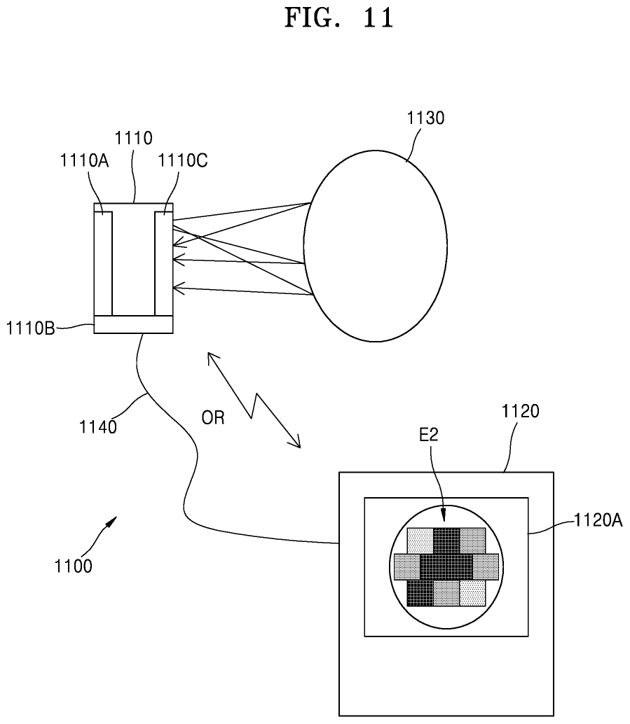

FIG. 11 illustrates a moisture distribution image measuring system 1100 according to an embodiment.

Referring to FIG. 11, the moisture distribution image measuring system 1100 includes a camera or camera module 1110 exclusively for photographing moisture distribution images and a display apparatus 1120 displaying a moisture distribution image. The camera module 1110 may be an example of a moisture distribution image photographing apparatus of a subject 1130. The camera module 1110 may be connected to the display apparatus 1120 with a wire 1140 or wirelessly. In an example, the camera module 1110 may be relatively large in volume compared to the camera modules 540, 710, and 1030 included in the first through fifth implements 500, 700, 800, 900, and 1000 described above, and the basic configuration of the camera module 1110 may be the same as that of the camera modules 540, 710, and 1030 described above. The camera module 1110 may include a light receiving unit 1110C and a circuit unit 1110B in a basic configuration. The light receiving unit 1110C may include the camera module 300 of FIG. 3 or the second camera module 400 of FIG. 4. The circuit unit 1110B for controlling an overall operation of the camera module 1110 may include the circuit module 310a and the communication module described with reference to FIG. 3. A moisture distribution image may be transmitted to the display apparatus 1120 through a communication module. A moisture distribution image of a specific part (for example, the skin of an entire face or the skin of forehead, cheek, arm, leg or hand) may be acquired through photographing the specific part of the subject 1130 while a user who is not the subject 1130 holds and moves the camera module 1110 by hands. A moisture distribution image E2 acquired on the specific part of the subject 1130 may be displayed through a display region 1120A of the display apparatus 1120. The display apparatus 1120 may store a moisture distribution image transmitted from the camera module 1110. The display apparatus 1120 may be one of external devices, and may be, for example, a mobile phone, a mobile pad, a computer, a TV or a medical monitor.

In another example, the camera module 1110 may be an exclusive moisture distribution image photographing camera including a memory unit and a display unit 1110A in addition to the configuration described above. The memory unit may be included in the circuit unit 1110B or may be provided as a separate chip connected to the circuit unit 1110B. The acquired moisture distribution image E2 may be viewed through the display unit 1110A.

By using the camera module 1110, the moisture distribution image of the specific part of the subject 1130 may be checked and stored in real time.

When the camera module 1110 is an exclusive moisture distribution image photographing camera that further includes the memory unit and the display unit 1110A, the camera module 1110 may be the moisture distribution image measuring system 1100 with only the camera module 1110 without the display apparatus 1120. When a color or monochrome camera module, which will be described later, is further mounted on the camera module 1110, the color or monochrome camera module may be mounted on a body of the camera module 1110. The body may be referred to as a frame of the camera module 1110.

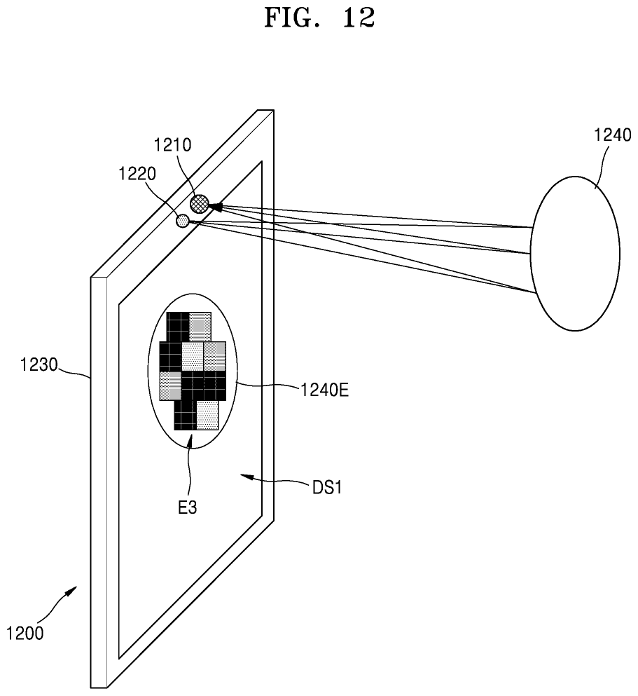

FIG. 12 shows a sixth implement 1200 including a camera module as a moisture distribution image photographing apparatus according to an embodiment.

Referring to FIG. 12, the sixth implement 1200 includes a camera module 1210 for photographing moisture distribution images, a light source 1220, and a display apparatus 1230. The display apparatus 1230 may be regarded as an electronic apparatus having an image display region DS1. The display apparatus 1230 may be a frame on which the camera module 1210 and the light source 1220 are mounted. The camera module 1210 may be the camera module 540 of the first implement 500 of FIG. 5 or may include the camera module 540. The light source 1220 may be the light source 560 of the first implement 500 of FIG. 5 or may include the light source 560. The camera module 1210 and the light source 1220 are mounted on the display apparatus 1230, and, for example, may be mounted on an upper central portion of a surface of the display apparatus 1230 facing a subject 1240. The camera module 1210 and the light source 1220 may be parts of elements constituting the display apparatus 1230. The display apparatus 1230 displays a moisture distribution image E3 acquired through photographing the subject 1240. The display apparatus 1230 may have a display region DS1 on a surface facing the subject 1240. The acquired moisture distribution image E3 is displayed on the display region DS1. Reference numeral 1240E indicates an image of the subject 1240 displayed in the display region DS1. Since the display region DS1 faces the subject 1240, when the subject 1240 is a user who uses the sixth implement 1200, the user may confirm a moisture distribution image of a specific part, for example, skin of face, hands, arms or legs in real time by using the sixth implement 1200.

The display apparatus 1230 may be, for example, a mobile phone or a mobile pad. As a result, the sixth implement 1200 may be a mobile phone or a mobile pad equipped with the camera module 1210 and the light source 1220 for photographing moisture distribution images. Therefore, the acquired moisture distribution image E3 may be stored in the display apparatus 1230 and/or transmitted to an external device through a communication function provided in the display apparatus 1230.

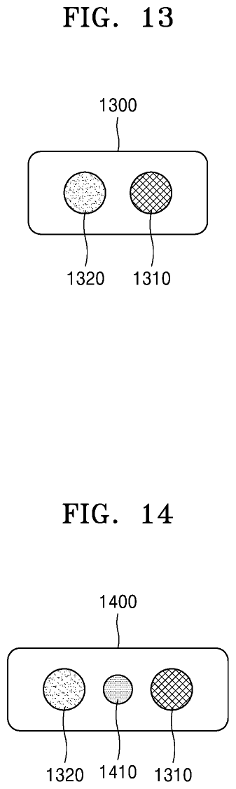

FIG. 13 shows a modification of the camera modules mounted to the above-mentioned implements for photographing moisture distribution images.

Referring to FIG. 13, the camera module 1300 includes a first camera module 1310 and a second camera module 1320. The first camera module 1310 may be a camera module for photographing moisture distribution images of a subject. The second camera module 1320 may be a camera module for photographing color or black and white images. The first camera module 1310 may be the camera module 540 included in the first implement 500 of FIG. 5 or may include the camera module 540. The second camera module 1320 may be a camera module for acquiring a color image or a black and white image of the subject. A further accurate information about a moisture distribution image of the subject may be acquired by synthesizing a moisture distribution image of the subject acquired by using the first camera module 1310 and a color image or a black and white image acquired by using the second camera module 1320. For example, it is possible to visually recognize the moisture distribution of each part of the subject more clearly by overlapping a moisture distribution image on a color or black and white image of the subject.

The synthesis of the moisture distribution image acquired through the first camera module 1310 and the moisture distribution image of the subject acquired through the second camera module 1320 may be performed by using an image synthesis algorithm. The image synthesis algorithm may be provided in a parent body on which the camera module 1300 is mounted. In another example, the image synthesis algorithm may be installed in an external device separated from the parent body. Here, the parent body may be the first through sixth implements 500, 700, 800, 900, 1000, and 1200 described above and the camera module 1110 of the moisture distribution image measuring system 1100 of FIG. 11. That is, the camera modules 540, 710, 1030, and 1210 of the first through sixth implements 500, 700, 800, 900, 1000, and 1200 and the light receiving unit 1110C of the camera module 1110 of the moisture distribution image measuring system 1100 of FIG. 11 may be replaced by the camera module 1300. The external device may be a device capable of receiving the moisture distribution image and the color or black and white image of the subject from the parent body or may include the device. For example, the external device may be the external device 600 of the first through fifth implements 500, 700, 800, 900, and 1000 or the display apparatus 1120 of the moisture distribution image measuring system 1100 of FIG. 11.

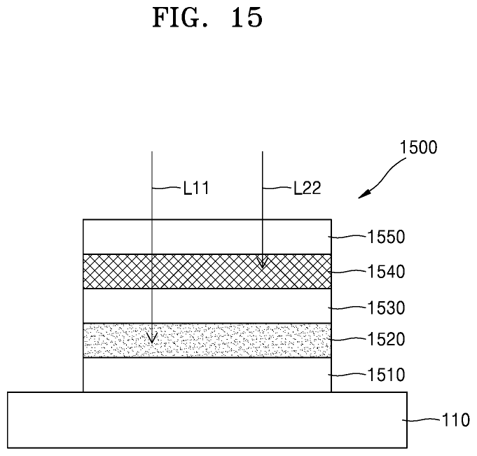

On the other hand, the camera module 1300 may also include a light source, and FIG. 14 shows an example of the light source.

Referring to FIG. 14, a camera module 1400 includes the first camera module 1310, the second camera module 1320, and a light source 1410. The light source 1410 may be disposed between the first camera module 1310 and the second camera module 1320. In another example, the light source 1410 may be disposed on a right side of the first camera module 1310 or a left side of the second camera module 1320. The light source 1410 may be a light source that emits infrared rays in a SWIR band, for example, the light source 1410 may be a first light source that emits only infrared rays in the SWIR band or may include the first light source. In another example, the light source 1410 may include a second light source that emits light including infrared light in a SWIR band or may include the second light source. The second light source may include a light source that emits visible light and infrared rays in a SWIR band. When the light source 1410 is the second light source, the first camera module 1310 may be the second camera module 400 of FIG. 4 including a band filter for blocking visible light.

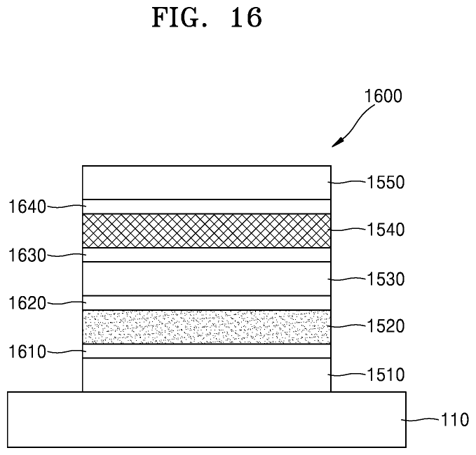

FIG. 15 shows a moisture sensor 1500 according to an embodiment.

Referring to FIG. 15, the moisture sensor 1500 may include a lower semiconductor layer 1510, a first photoelectric conversion layer 1520, an intermediate semiconductor layer 1530, a second photoelectric conversion layer 1540, and upper semiconductor layer 1550 that are sequentially stacked on the substrate 110. In an example, the lower semiconductor layer 1510 and the upper semiconductor layer 1550 may be semiconductor layers doped with a p-type impurity, and the intermediate semiconductor layer 1530 may be a semiconductor layer doped with an n-type impurity. The lower semiconductor layer 1510, the first photoelectric conversion layer 1520, and the intermediate semiconductor layer 1530 may act as a lower sensor. The intermediate semiconductor layer 1530, the second photoelectric conversion layer 1540, and the upper semiconductor layer 1550 may act as an upper sensor. In the moisture sensor 1500, the intermediate semiconductor layer 1530 may be used as a common terminal of the upper and lower sensors. The lower and upper semiconductor layers 1510 and 1550 may be the same as the second semiconductor layer 140 of FIG. 1. The intermediate semiconductor layer 1530 may be the same as the first semiconductor layer 120 of FIG. 1. One of the first photoelectric conversion layer 1520 and the second photoelectric conversion layer 1540 may be the same as the photoelectric conversion layer 130 of FIG. 1, and the remaining photoelectric conversion layers may have the same layer configuration as the photoelectric conversion layer 130 of FIG. 1, but the forming material may be different.

For example, the first photoelectric conversion layer 1520 may be the same as the photoelectric conversion layer 130 of FIG. 1. Accordingly, the first photoelectric conversion layer 1520 may include a material layer that shows a relatively large photoelectric conversion efficiency with respect to a SWIR L11 having a central wavelength of 1450 nm or 1920 nm corresponding to a moisture absorption wavelength. In this case, the lower sensor including the first photoelectric conversion layer 1520 may act as a moisture sensor. The second photoelectric conversion layer 1540 is a material layer that absorbs infrared rays in the SWIR band and causes a photoelectric conversion, but a central wavelength of absorbing wavelength is different from the moisture absorption wavelength. In an example, the second photoelectric conversion layer 1540 may include a material layer having a relatively high photoelectric conversion efficiency with respect to a SWIR L22 having a center wavelength of 1310 nm, 1620 nm, or 2050 nm. In this case, the upper sensor including the second photoelectric conversion layer 1540 may function as a non-moisture sensor. The position of the upper sensor and the lower sensor may be interchanged.

The upper sensor including the second photoelectric conversion layer 1540 may be transparent with respect to the SWIR L11 having a central wavelength of 1450 nm or 1920 nm. Accordingly, of the incident light beams L11 and L22 having different wavelengths, the SWIR L11 having a center wavelength of 1450 nm or 1920 nm reaches the first photoelectric conversion layer 1520 through the upper sensor, and the SWIR L22 having a center wavelength of 1310 nm, 1620 nm, or 2050 nm does not reach the first photoelectric conversion layer 1520.

Meanwhile, the moisture sensor 1500 may become a detector that detects two or more incident lights having different center wavelengths from each other by adding one or more photoelectric conversion layers to the moisture sensor 1500.

FIG. 16 shows a moisture sensor 1600 according to an embodiment.

Referring to FIG. 16, the moisture sensor 1600 is formed by adding a plurality of DBR layers 1610, 1620, 1630, and 1640 to the moisture sensor 1500 of FIG. 15. The plurality of DBR layers 1610, 1620, 1630, and 1640 may be disposed in parallel to each other. The layer structure and the forming material of each of the plurality of DBR layers 1610, 1620, 1630, and 1640 may be the same as one of the DBR layers 150 and 160 of FIG. 1. The first DBR layer 1610 is disposed between the lower semiconductor layer 1510 and the first photoelectric conversion layer 1520. The second DBR layer 1620 is disposed between the first photoelectric conversion layer 1520 and the intermediate semiconductor layer 1530. The third DBR layer 1630 is disposed between the intermediate semiconductor layer 1530 and the second photoelectric conversion layer 1540. The fourth DBR layer 1640 is disposed between the second photoelectric conversion layer 1540 and the upper semiconductor layer 1550.

The moisture sensors 210, 220, 230, and 240 included in the moisture sensor array of FIG. 2 may be replaced by the moisture sensor 1500 of FIG. 15 or the moisture sensor 1600 of FIG. 16. In this case, an infrared image of a subject with respect to two incident lights having different center wavelengths of the SWIR band may be obtained through the above-described camera modules having the moisture sensor array of FIG. 2 as an image sensor. For example, an image of the subject (hereinafter, as a first image) with respect to first incident light having a center wavelength of 1450 nm or 1920 nm and an image of the subject (hereinafter, a second image) with respect to second incident light having a center wavelength deviated from 1450 nm or 1920 nm may be obtained.

The first image and the second image may be produced by using the above-described camera modules in which the moisture sensor array of FIG. 2 is employed as it is without replacing the moisture sensors 210, 220, 230, and 240 included in the moisture sensor array of FIG. 2 with the moisture sensor of FIG. 15 or 16. For example, the first image may be obtained by photographing a subject by using the second camera module 400 of FIG. 4 and the first incident light. Next, after replacing the band pass filter 410 with that of the second incident light, and the second image may be obtained by photographing the subject using the second incident light.

A wavelength of the second incident light may be different from the moisture absorption wavelength, for example, an infrared ray having a center wavelength of 1310 nm, 1620 nm, or 2050 nm. The first image may include a moisture distribution image of the subject. Although the second image is an image of the subject, but the wavelength of the second incident light is not a moisture absorption wavelength, and thus, the second image does not include a moisture distribution image. The second image may be an image of the subject and its background color except for a moisture distribution image. The first and second images may also include images caused by external light and/or noise. Through subtracting the second image from the first image, an image by the background color, external light, and/or noise may be removed, and thus, a moisture distribution image with respect to the subject may be obtained.

In this way, after photographing an image by a moisture absorption wavelength and photographing an image by a wavelength different from the moisture absorption wavelength, the image by the wavelength different from the moisture absorption wavelength is subtracted from the image by the moisture absorption wavelength, and thus, a moisture distribution image in which the influence of external light and/or noise is minimized or eliminated and having high reliability may be acquired.

The moisture distribution image photographing apparatus according to an embodiment includes an array consisting of moisture sensors as an image sensor. The camera module includes a light source that emits SWIRs, and since the image sensor has a relatively high sensitivity with respect to a moisture absorption wavelength of SWIRs, the quality of a moisture distribution image is increased and a separate band pass filter is unnecessary, and thus, the configuration of the camera module may be relatively simplified.

Also, the photoelectric conversion layer of the illustrated moisture sensor has a small wavelength change according to temperature. Accordingly, in the case of the camera module which is an example of the illustrated moisture distribution image photographing apparatus, the camera module does not need a relatively bulky component such as a cooler, and thus, the moisture distribution image photographing apparatus may be miniaturized.

The moisture distribution image photographing apparatus illustrated above may be used to measure moisture at a specific point of a subject through point contact of the subject like an existing moisture measurement apparatus, and also, the illustrated moisture distribution image photographing apparatus may be mainly used to photograph and measure a moisture distribution image of a large area of a subject. The moisture distribution image photographing apparatus illustrated above may be operated in a non-contact and non-invasive state with respect to a subject. That is, the moisture distribution image photographing apparatus illustrated above may be used away from a subject by a distance sufficient to photograph a moisture distribution image of a predetermined region of the subject. Since the photographing of a moisture distribution image with respect to a subject may be performed in real time, the control of moisture distribution of an entire region or a part of the predetermined region of the subject may be performed in real time or rapidly as real time.

The moisture distribution image photographing apparatus according to an embodiment may photograph a moisture distribution image with respect to the whole or a part of a predetermined area of a subject at a distance from the subject, and thus, it is possible to widen its application range and provide various solutions for acquiring moisture distribution images with respect to a subject by combining the moisture distribution image photographing apparatus with various devices (for example, LED masks, smart mirrors, mobile phones, etc.). For example, before, in order to measure a moisture distribution of an entire face, a bulky device capable of accommodating the entire face was required and the bulky device is relatively expensive and hard to carry, but a device equipped with the moisture distribution image photographing apparatus according to an embodiment is small enough to be easily carried by a user and is inexpensive compared to an existing moisture distribution measuring apparatus, and thus, when a device equipped with the illustrated moisture distribution image photographing device is used, inconveniences of the existing moisture distribution measuring apparatus may be removed.

While embodiments of the disclosure have been particularly shown and described with reference to the drawings, the embodiments are provided for the purposes of illustration and it will be understood by one of ordinary skill in the art that various modifications and equivalent other embodiments may be made from the disclosure. Accordingly, the true technical scope of the disclosure is defined by the technical spirit of the appended claims.

What is claimed is:

1. A moisture distribution image photographing apparatus comprising:
a substrate;
an image sensor mounted on the substrate; and
a lens collecting incident light on the image sensor,
wherein the substrate comprises a circuit module for driving the image sensor and processing an image obtained through the image sensor, and
the image sensor comprises a moisture sensor array having a main absorption wavelength band of 1450±50 nm or 1920±50 nm.

2. The moisture distribution image photographing apparatus of claim 1, wherein a moisture distribution image is obtained through the image sensor, and
the circuit module comprises a communication module for transmitting the moisture distribution image to the outside of the moisture distribution image photographing apparatus.

3. The moisture distribution image photographing apparatus of claim 1, further comprising a band pass filter for blocking visible light.

4. The moisture distribution image photographing apparatus of claim 1, further comprising a communication module configured to transmit a moisture distribution image to the outside of the moisture distribution image photographing apparatus,
wherein the communication module is connected to the circuit module.

5. A skin care apparatus having a moisture distribution image photographing function, the skin care apparatus comprising:
a frame having at least one function; and
a moisture distribution image photographing apparatus mounted on the frame,
wherein the moisture distribution image photographing apparatus comprises:
a substrate,
an image sensor mounted on the substrate, and
a lens collecting incident light on the image sensor,
the substrate comprises:
a circuit module for driving the image sensor and processing a moisture distribution image obtained through the image sensor, and
the image sensor comprises a moisture sensor array having a main absorption wavelength band of 1450±50 nm or 1920±50 nm.

6. The skin care apparatus of claim 5, wherein the circuit module comprises a communication module for transmitting the obtained moisture distribution image to the outside of the moisture distribution image photographing apparatus.

7. The skin care apparatus of claim 5, wherein the moisture distribution image photographing apparatus further comprises a band pass filter for blocking visible light.

8. The skin care apparatus of claim 5, wherein a light source configured to emit only infrared light in a short wavelength infrared ray band is further provided to the frame.

9. The skin care apparatus of claim 5, wherein a color camera module or a black and white camera module is further mounted on the frame.

10. The skin care apparatus of claim 5, wherein the frame comprises a display region for displaying a moisture distribution image obtained through the moisture distribution image photographing apparatus.

11. The skin care apparatus of claim 8, wherein a light emitting diode (LED) is further provided to the frame.

12. The skin care apparatus of claim 8, wherein the frame comprises a light emitting diode (LED) mask.

13. The skin care apparatus of claim 8, wherein the frame is provided with a plurality of light sources, and a number of moisture distribution image photographing apparatuses mounted on the frame is equal to a number of the plurality of light sources.

14. A skin care system comprising:
the skin care apparatus of claim 5, the skin care apparatus having the moisture distribution image photographing function with respect to a subject; and
an external device having a display region for displaying the moisture distribution image transmitted from the skin care apparatus

15. The skin care system of claim 14, wherein the skin care apparatus and the external device are connected to each other by a wire or wirelessly.

16. The skin care system of claim 14, wherein the external device comprises an electronic device comprising a display panel for displaying a moisture distribution image transmitted from the skin care apparatus to be viewed by a user.

17. The skin care system of claim 14, wherein the external device comprises an algorithm configured to synthesize the moisture distribution image of the subject obtained through the skin care apparatus and a black and white image or a color image of the subject.

18. The skin care system of claim 14, wherein the circuit module comprises a communication module configured to transmit the moisture distribution image to the outside of the moisture distribution image photographing apparatus.

19. The skin care system of claim 14, wherein the moisture distribution image photographing apparatus further comprises a band pass filter configured to block visible light.

20. The skin care system of claim 14, wherein a light source that emits only infrared light in a short wavelength infrared ray band is further provided on the frame.

21. The skin care system of claim 14, wherein a color camera module or a black and white camera module is further mounted on the frame.

22. The skin care system of claim 14, wherein the frame comprises a frame display region for displaying the moisture distribution image obtained through the moisture distribution image photographing apparatus.

23. The skin care system of claim 14, wherein a light emitting diode (LED) is further provided on the frame.

24. The skin care system of claim 14, wherein the frame comprises a light emitting diode (LED) mask.

25. The skin care system of claim 14, wherein a plurality of light sources are provided on the frame, and moisture distribution image photographing apparatuses are mounted in the same number as a number of the plurality of light sources.
